(19) United States
(12) Patent Application Publication
(10) Pub. No.: US 2026/0282062 A1
(43) Pub. Date: Sep. 17, 2026

(54) USER EQUIPMENT CAPABILITY INFORMATION SIGNALING

(71) Applicant: QUALCOMM Incorporated, San Diego, CA (US)

(72) Inventors: Akalankam SAI TEJA, Hyderabad (IN); Sarath Kumar PUJARI, Hyderabad (IN); Ansah Ahmed SHEIK, Hyderabad (IN); Daniel AMERGA, San Diego, CA (US); Sindhu SATYAN, San Diego, CA (US); Hitesh JAIN, Hyderabad (IN); Mitul VOHRA, Hyderabad (IN)

(21) Appl. No.: 19/078,734

(22) Filed: Mar. 13, 2025

(51) Int. Cl. H04W 72/51; H04W 72/0453; H04W 88/08

(52) U.S. Cl. CPC H04W 72/51; H04W 72/0453; H04W 88/08

(57) ABSTRACT

Methods, systems, and devices for wireless communications are described. A user equipment (UE) may transmit a UE capability message that comprises a band combination identifier that identifies a plurality of band combinations supported by the UE for wireless communications, wherein each identifier in the band combination identifier corresponds to a sequential position of uplink bands within each band combination of the plurality of band combinations and each band combination comprises a sequential listing of both uplink bands and downlink bands. The UE may perform the wireless communications using one or more band combinations of the plurality of band combinations supported by the UE in accordance with the UE capability message.

### FIELD OF TECHNOLOGY

The following relates to wireless communications, including user equipment capability information signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and performing the wireless communications using one or more band combinations of the set of multiple band combinations supported by the UE in accordance with the UE capability message.

A UE for wireless communications is described. The UE may include one or more memories storing processor executable code, and one or more processors coupled with the one or more memories. The one or more processors may individually or collectively be operable to execute the code to cause the UE to transmit a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and perform the wireless communications using one or more band combinations of the set of multiple band combinations supported by the UE in accordance with the UE capability message.

Another UE for wireless communications is described. The UE may include means for transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and means for performing the wireless communications using one or more band combinations of the set of multiple band combinations supported by the UE in accordance with the UE capability message.

A non-transitory computer-readable medium storing code for wireless communications is described. The code may include instructions executable by one or more processors to transmit a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and perform the wireless communications using one or more band combinations of the set of multiple band combinations supported by the UE in accordance with the UE capability message.

In some examples of the method, user equipment (UEs), and non-transitory computer-readable medium described herein, the band combination identifier includes a set of integer values and each band combination in the set of multiple band combinations may be associated with a unique integer in the set of integer values.

In some examples of the method, user equipment (UEs), and non-transitory computer-readable medium described herein, each unique integer corresponds to a sequential position of uplink bands in each band combination.

In some examples of the method, user equipment (UEs), and non-transitory computer-readable medium described herein, the set of integer values may be associated with a matrix, the matrix based on a quantity of available uplink band positions in available band combinations.

Some examples of the method, user equipment (UEs), and non-transitory computer-readable medium described herein may further include operations, features, means, or instructions for receiving a table that identifies a set of integer values for each band combination in available band combinations, where the band combination identifier may be associated with the table.

In some examples of the method, user equipment (UEs), and non-transitory computer-readable medium described herein, the band combination identifier may be associated with a number of concurrent uplink communications supported by the UE.

In some examples of the method, user equipment (UEs), and non-transitory computer-readable medium described herein, the band combination identifier may be associated with a number of bands in the set of multiple band combinations supported by the UE and a number of uplink bands in each band combination.

Some examples of the method, user equipment (UEs), and non-transitory computer-readable medium described herein may further include operations, features, means, or instructions for generating, according to a first algorithm, a set of unique integer values for each band combination in the available band combinations, where the band combination identifier may be based on the set of unique integer values.

Some examples of the method, user equipment (UEs), and non-transitory computer-readable medium described herein may further include operations, features, means, or instructions for generating, according to a second algorithm, the band combination identifier based on the number of bands in the set of multiple band combinations supported by the UE and the number of uplink bands in each band combination.

In some examples of the method, user equipment (UEs), and non-transitory computer-readable medium described herein, the UE capability message includes a first information element that identifies a number of band combinations and second information element that identifies a number of uplink bands in each band combination.

In some examples of the method, user equipment (UEs), and non-transitory computer-readable medium described herein, the UE capability message includes an indication of a number of band combinations included in the set of multiple band combinations supported by the UE.

A method for wireless communications by a network entity is described. The method may include receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and performing the wireless communications with the UE using one or more band combinations of the set of multiple band combinations supported by the UE in accordance with the UE capability message.

A network entity for wireless communications is described. The network entity may include one or more memories storing processor executable code, and one or more processors coupled with the one or more memories. The one or more processors may individually or collectively be operable to execute the code to cause the network entity to receive a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and perform the wireless communications with the UE using one or more band combinations of the set of multiple band combinations supported by the UE in accordance with the UE capability message.

Another network entity for wireless communications is described. The network entity may include means for receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and means for performing the wireless communications with the UE using one or more band combinations of the set of multiple band combinations supported by the UE in accordance with the UE capability message.

A non-transitory computer-readable medium storing code for wireless communications is described. The code may include instructions executable by one or more processors to receive a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands and perform the wireless communications with the UE using one or more band combinations of the set of multiple band combinations supported by the UE in accordance with the UE capability message.

In some examples of the method, network entities, and non-transitory computer-readable medium described herein, the band combination identifier includes a set of integer values and each band combination in the set of multiple band combinations may be associated with a unique integer in the set of integer values.

In some examples of the method, network entities, and non-transitory computer-readable medium described herein, each unique integer corresponds to a sequential position of uplink bands in each band combination.

In some examples of the method, network entities, and non-transitory computer-readable medium described herein, the set of integer values may be associated with a matrix, the matrix based on a quantity of available uplink band positions in available band combinations.

Some examples of the method, network entities, and non-transitory computer-readable medium described herein may further include operations, features, means, or instructions for transmitting a table that identifies a set of integer values for each band combination in available band combinations, where the band combination identifier may be associated with the table.

In some examples of the method, network entities, and non-transitory computer-readable medium described herein, the band combination identifier may be associated with a number of concurrent uplink communications supported by the UE.

In some examples of the method, network entities, and non-transitory computer-readable medium described herein, the band combination identifier may be based on a number of bands in the set of multiple band combinations supported by the UE and a number of uplink bands in each band combination.

Some examples of the method, network entities, and non-transitory computer-readable medium described herein may further include operations, features, means, or instructions for generating, according to a first algorithm, a set of unique integer values for each band combination in the available band combinations, where the band combination identifier may be based on the set of unique integer values.

In some examples of the method, network entities, and non-transitory computer-readable medium described herein, the band combination identifier may be based on the number of bands in the set of multiple band combinations supported by the UE and the number of uplink bands in each band combination.

In some examples of the method, network entities, and non-transitory computer-readable medium described herein, the UE capability message includes a first information element that identifies a number of band combinations and second information element that identifies a number of uplink bands in each band combination.

In some examples of the method, network entities, and non-transitory computer-readable medium described herein, the UE capability message includes an indication of a number of band combinations included in the set of multiple band combinations supported by the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports user equipment (UE) capability information signaling in accordance with one or more aspects of the present disclosure.

FIG. 2 shows an example of a wireless communications system that supports UE capability information signaling in accordance with one or more aspects of the present disclosure.

FIG. 3 shows an example of an algorithm that supports UE capability information signaling in accordance with one or more aspects of the present disclosure.

FIG. 4 shows an example of a method that supports UE capability information signaling in accordance with one or more aspects of the present disclosure.

FIGS. 5 and 6 show block diagrams of devices that support UE capability information signaling in accordance with one or more aspects of the present disclosure.

FIG. 7 shows a block diagram of a communications manager that supports UE capability information signaling in accordance with one or more aspects of the present disclosure.

FIG. 8 shows a diagram of a system including a device that supports UE capability information signaling in accordance with one or more aspects of the present disclosure.

FIGS. 9 and 10 show block diagrams of devices that support UE capability information signaling in accordance with one or more aspects of the present disclosure.

FIG. 11 shows a block diagram of a communications manager that supports UE capability information signaling in accordance with one or more aspects of the present disclosure.

FIG. 12 shows a diagram of a system including a device that supports UE capability information signaling in accordance with one or more aspects of the present disclosure.

FIGS. 13 through 16 show flowcharts illustrating methods that support UE capability information signaling in accordance with one or more aspects of the present disclosure.

### DETAILED DESCRIPTION

Wireless networks may use various combinations of bands (e.g., radio frequency spectrum bands) for wireless communications between user equipment (UE) and the network. The network may advertise (e.g., in a broadcast message or in a unicast message) the available band combinations to the UE (e.g., such as in a supported band combination list). Each band combination may include a plurality of uplink bands and downlink bands available for wireless communications. Each UE may receive the available band combinations and determine which band combinations they can use for wireless communications. For example, the UE may determine which bands it supports communicating on based on the capabilities of the UE, such as how many uplink bands the UE supports simultaneous communications on. The UE may signal (e.g., in UE capability signaling) the band combinations that it supports to the network, which may use this information when scheduling the wireless communications with the UE. However, in such wireless networks the UE generally signals identifying information corresponding to each band combination supported by the UE for wireless communications. This may consume excessive uplink resources as some UE may support hundreds of different band combinations.

Accordingly, aspects of the techniques described herein provide for improved UE capability signaling based on a band combination identifier. For example, the UE may transmit a UE capability message to a network entity that carries or otherwise conveys the band combination identifier. The band combination identifier may identify a plurality of band combinations supported by the UE for wireless communications from the available band combinations. The band combination identifier may be based on a sequential position of uplink bands within each band combination of the plurality of band combinations. As discussed, each band combination may include a sequential listing of both uplink bands and downlink bands. The UE may generate the band combination identifier from the band combinations that it supports for wireless communications based on the position of the uplink bands within the band combination (e.g., whether the uplink band is in the first position within the band combination, the second position, etc.). A natural number (e.g., an integer value) may be assigned to each band combination supported by the UE and the band combination identifier may include the natural numbers corresponding to the supported band combinations. Accordingly, the UE may perform the wireless communications using one or more band combinations of the plurality of band combinations supported by the UE in accordance with the UE capability message.

Aspects of the disclosure are initially described in the context of wireless communications systems. Aspects of the disclosure are further illustrated by and described with reference to apparatus diagrams, system diagrams, and flowcharts that relate to UE capability information signaling.

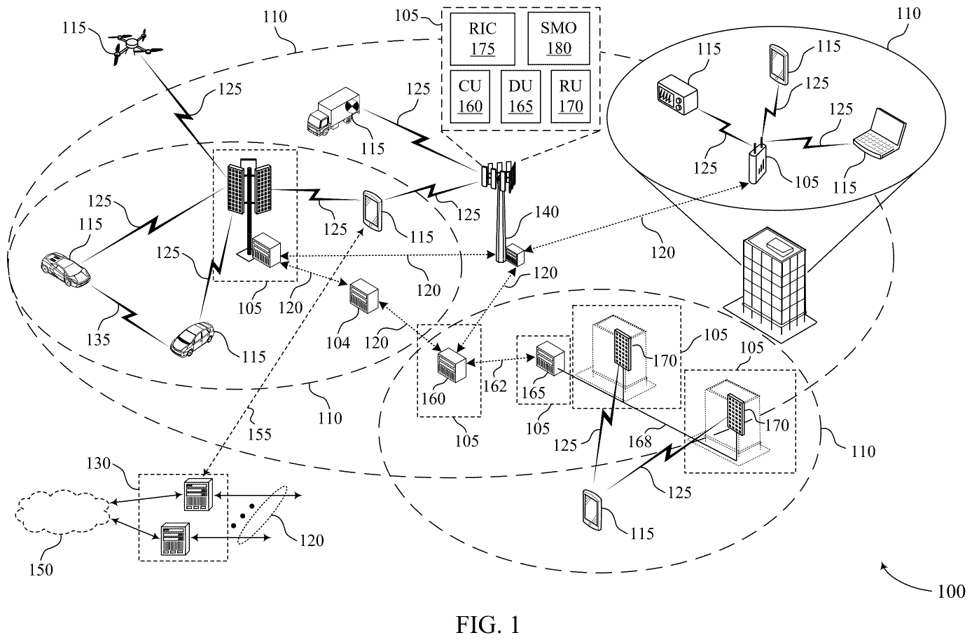

FIG. 1 shows an example of a wireless communications system 100 that supports UE capability information signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support UE capability information signaling as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit a UE capability message that includes or conveys a band combination identifier that identifies a plurality of band combinations supported by the UE 115 for wireless communications, wherein each identifier in the band combination identifier corresponds to a sequential position of uplink bands within each band combination of the plurality of band combinations and each band combination comprises a sequential listing of both uplink bands and downlink bands. The UE 115 may perform the wireless communications using one or more band combinations of the plurality of band combinations supported by the UE 115 in accordance with the UE capability message.

A network entity 105 may receive a UE capability message that comprises a band combination identifier that identifies a plurality of band combinations supported by the UE 115 for wireless communications, wherein each identifier in the band combination identifier corresponds to a sequential position of uplink bands within each band combination of the plurality of band combinations and each band combination comprises a sequential listing of both uplink bands and downlink bands. The network entity 105 may perform the wireless communications with the UE 115 using one or more band combinations of the plurality of band combinations supported by the UE 115 in accordance with the UE capability message.

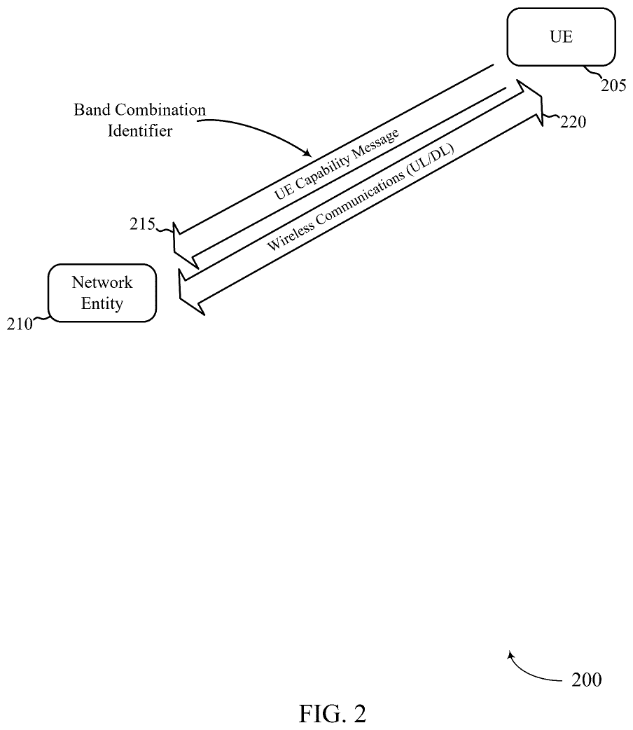

FIG. 2 shows an example of a wireless communications system 200 that supports UE capability information signaling in accordance with one or more aspects of the present disclosure. Aspects of the wireless communications system 200 may implement aspects of or be implemented by aspects of the wireless communications system 100. The wireless communications system 200 may include a UE 205 and a network entity 210, which may be examples of the corresponding devices described herein.

Wireless networks may use a frequency band list (frequencyBandList) to support wireless communications. The frequency band list may correspond to or otherwise specify the frequency bands that are available for a device to use for wireless communications. The frequency bands may include frequency range one (FR1) band(s), frequency range two (FR2), bands, or other frequency ranges supported for the wireless communications. Each band may be identified by or otherwise correspond to a unique n number (e.g., n1, n2, n3, etc.). The frequency band list may be broadcast, RRC configured, or otherwise provided to each device (e.g., each UE, such as the UE 205).

Moreover, the wireless network may broadcast, RRC configure, or otherwise provide a list of available band combinations that can be supported by each device and the device may signal its supported band combinations to the network (e.g., via UE capability signaling). The device may choose the band combinations based on the frequency band list (e.g., a frequencyBandListFilter) as well as internal prioritization logic to filter the band combinations (e.g., such as the number of concurrent uplink transmissions the device supports). Each band combination may include a list (e.g., a sequential list) or one or more uplink bands and one or more downlink bands. The bands in the band combination may be associated with different channel bandwidths (e.g., for both the uplink bands and the downlink bands), different duplexing modes, FDD vs TDD configurations, and other distinguishing characteristics. Given that there may be a large number of bands, the number of available band combinations may be extensive. For example, radio frequency (RF) cards in some devices may support more than 105 band combinations, out of which a UE may try to accommodate 400 different band combinations (up to 1500 band combinations with protocol data unit (PDU) segmentation).

The size of an RRC uplink over-the-air (OTA) message may be limited to a maximum PDU size. In some cases, this maximum PDU size may be 8 kb for a non-stand-alone (NSA) mode and 9 kb for a stand-alone (SA) mode. With PDU segmentation, the PDU size may be multiplied up to 16 times. Given the case without segmentation, choosing up to 400 band combinations and packing this information (e.g., the band combination identifier or other information identifying each supported band combination) may be difficult for the UE. For example, signaling individual information identifying each supported band combination for up to 400 band combinations (or more) may consume a considerable amount of the PDU size. This issue quickly becomes more compounded with segmentation.

As one example, a frequency and time uplink CA band combination may include an uplink band on one FDD carrier and another uplink band on a TDD carrier. In this example, the band combinations supported by the UE may include:

$$n 1 AA [ 1 \times 50 ] + n 2 A + n 5 A + n 7 A + n 41 AA [ 1 \times 100 ] + n 78 A$$

$$n 1 A + n 2 AA [ 1 \times 50 ] + n 5 A + n 7 A + n 41 AA [ 1 \times 100 ] + n 78 A$$

$$n 1 A + n 2 A + n 5 A + n 7 AA [ 1 \times 50 ] + n 41 AA [ 1 \times 100 ] + n 78 A$$

$$n 1 A + n 2 A + n 5 AA [ 1 \times 50 ] + n 7 A + n 41 A + n 78 AA [ 1 \times 100 ]$$

$$n 1 A + n 2 A + n 5 A + n 7 AA [ 1 \times 50 ] + n 41 A + n 78 AA [ 1 \times 100 ]$$

These bands may be selected or otherwise identified by the UE from all available band combinations supported by the network. In this example, the n number may refer to the band (e.g., n1, n2, etc.), A may refer to downlink bands (e.g., n2A, n5A, etc.), and AA may refer to uplink bands (e.g., n1AA, n42AA, etc.). In this example, the first uplink band is associated with a 50 MHz channel bandwidth (e.g., [1×50]) and the second uplink band is associated with a 100 MHz channel bandwidth (e.g., [1×100]. Thus, in this example there may be two uplink frequency spectrums corresponding to AA [1×50] with a frequency spectrum uplink identifier of 202 and to AA [1×100] with a frequency spectrum uplink identifier of 203. As can be seen in this example, both the uplink frequency spectrums (202, 203) may hover around the FDD/TDD bands in these band combinations. Other combinations of bands and associated channel bandwidths may be supported.

According to some wireless networks, all of these band combinations are being advertised as different band combinations as part of the supported band combination list (e.g., supportedBandCombinationList) information signaled to the network in the UE capability signaling. As discussed above, in some examples the band combinations supported by a UE may be in the hundreds, which may consume a considerable amount of uplink data and overhead.

Accordingly, the techniques described herein provide for optimized or otherwise improved UE capability signaling (e.g., in relation to the band combinations supported by the UE 205). The UE capability signaling may be based on the UE 205 signaling a band combination identifier to the network rather than individual information identifying each supported band combination. This approach may create more space in the UE capability signaling (e.g., to allow the UE 205 to indicate support for additional band combinations). The techniques described herein combine all such different band combinations into a base band combination (e.g., a band combination identifier) that represents all five of the band combinations (e.g., in the example shown above).

For example, at 215 the UE 205 may transmit or otherwise output (and the network entity 210 may receive or otherwise obtain) a UE capability message that carries or otherwise conveys an indication of or information associated with the band combination identifier. The band combination identifier may identify a plurality of band combinations supported by the UE 205 for wireless communications. For example, the band combination identifier may identify the supported band combinations from some or all of the available band combinations. The band combination identifier may be based on or otherwise determined based on the sequential position of the uplink bands within each band combination of the plurality of band combinations.

As shown in the example above, each band combination may include a sequential listing (e.g., in order from first (the 0^{th} position) to the last band (the N^{th} position) included in the band combination) of both the uplink bands and the downlink bands. Accordingly, at 220 the UE 205 and the network entity 210 may perform the wireless communications using one or more band combinations (e.g., one, some, or all of the bands in a band combination) of the plurality of band combinations supported by the UE 205 according to the UE capability message. For example, the network entity 210 may use the band combinations reported in the UE capability message for scheduling determinations related to the UE 205.

Broadly, the UE 205 and the network entity 210 may both capture or otherwise identify all the valid hovering uplink positions and map those uplink position coordinates (e.g., in a two-dimensional mapping, a three-dimensional mapping, etc.). The mapping may be based on the number of uplink bands in the band combination to a natural number (e.g., a unique integer value). The band combination identifier may be identified, selected, or otherwise determined according to the mapping and the band combinations supported by the UE 205.

Continuing with the example supported band combinations shown above, the band combinations each include six bands and two uplink bands in each band combination. The possible uplink band position coordinates (e.g., the sequential listing order) in this example may correspond to Table 1 below.

TABLE 1

| (UL1 position, UL2 position) | Band Combination Identifier |
|---|---|
| (0, 0) | X |
| (0, 1) | 1 |
| (0, 2) | 2 |
| (0, 3) | 3 |
| (0, 4) | 4 |
| (0, 5) | 5 |
| (1, 0) | 6 |
| (1, 1) | X |
| (1, 2) | 7 |
| (1, 3) | 8 |
| (1, 4) | 9 |
| (1, 5) | 10 |
| (2, 0) | 11 |
| (2, 1) | 12 |
| (2, 2) | X |
| . . . | . . . |

In Table 1, a band combination identifier shown as X may refer to an invalid reference based on two uplink bands in the band combinations not being at the same sequential position (e.g., two, different uplink bands cannot be at the 1^{st} sequential order in a band combination). Table 1 may illustrate partial set of unique integer values for each band combination in the available band combinations.

Accordingly, to identify or otherwise determine the band combination identifier the UE 205 may use the example band combinations provided above and Table 1. In this example, the band combinations supported by the UE 205 includes six bands per-band combination with two uplink bands in each band combination. In some cases, this may correspond to the time and frequency uplink CA. The band indices may start from “0” and proceed to the N^{th} band combination, wherein N is the number of band combinations supported by the UE 205. According to the first band combination “n1AA [1×50]+n2A+n5A+n7A+n41AA [1×100]+n78A” shown in the example above, the index “0” (e.g., the first sequential position or 0^{th} position in the band combination) may correspond to the n1AA uplink band. The index “1” (e.g., the second sequential position in the band combination) may correspond to the N2A downlink band. The index “2” may correspond to the n5A downlink band. This may continue for each of the six positions in the band combination.

The first uplink band in this band combination (e.g., n1AA with a 50 MHz channel bandwidth) may correspond to the first uplink band (e.g., UL1, 202) and the next uplink band in this band combination (e.g., N41AA with a 100 MHz channel bandwidth) may correspond to the second uplink band (e.g., UL2, 203). Accordingly, the uplink positions can be inferred from the coordinates (0,4). That is, the coordinate (0,4) may indicate that the first uplink band is on the 0^{th} band or index and the second uplink band is on the 4^{th} band or index in the band combination.

According to Table 1, this combination of uplink positions (0,4) may be mapped to a natural number value 4 (e.g., the unique integer value for this band combination may be referenced as 4). Similarly, position combination (1,5) may infer that the first uplink band is on the 1^{st} band and the second uplink band is on the 5^{th} band in the band combination. From Table 1, position combinations (1,5) may map to the value 10 (e.g., the unique integer value for this band combination may be referenced as 10). Again, the position combination (0,0), (1,1), etc., are not valid because both the first uplink band and the second uplink band cannot be on the same (e.g., 0^{th}, 1^{st}, etc.,) band in the band combination. The UE 205 may use this approach to generate the band combination identifier based on the unique integer value corresponding to each band combination in the plurality of band combinations supported by the UE 205 for wireless communications. That is, in this example each unique integer may correspond to a sequential position of uplink bands in each band combination.

Accordingly, the UE 205 may identify the unique integer value corresponding to each band combination supported by the UE 205 and this set of unique integer values may form the band combination identifier that is signaled to the network entity 210 in the UE capability message.

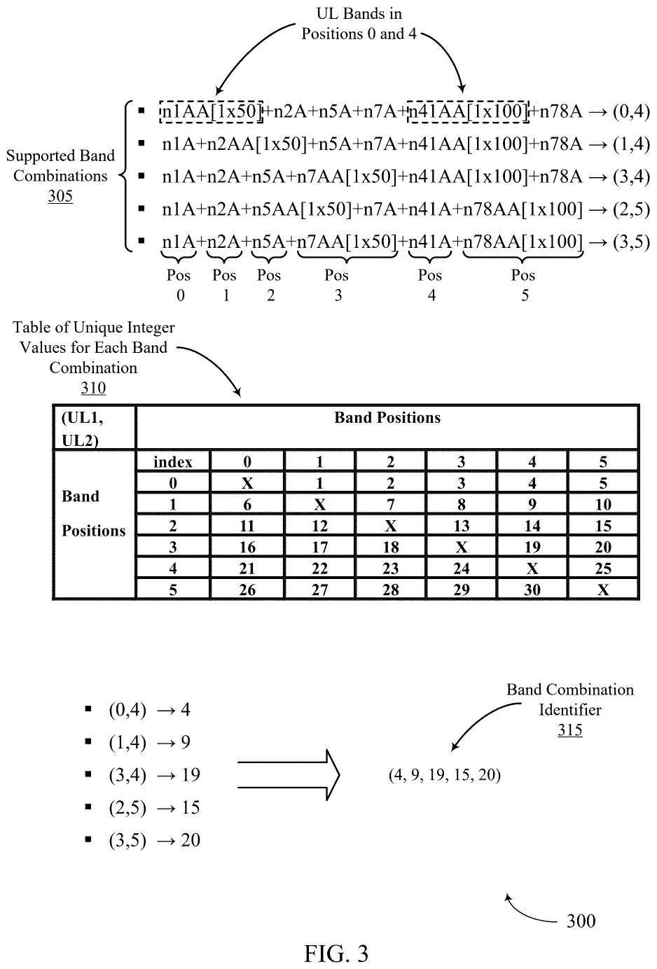

FIG. 3 shows an example of an algorithm 300 that supports UE capability information signaling in accordance with one or more aspects of the present disclosure. Aspects of the algorithm 300 may be implemented at or implemented by aspects of the wireless communications system 100 or the wireless communications system 200. For example, aspects of the algorithm 300 may be implemented at or implemented by a UE or a network entity, which may be examples of the corresponding devices described herein.

As discussed above, the techniques described herein provide for UE capability signaling (e.g., in relation to the band combinations supported by the UE). The UE capability signaling may be based on the UE signaling a band combination identifier to the network rather than individual information identifying each supported band combination. This approach may create more space in the UE capability signaling (e.g., to allow the UE to indicate support for additional band combinations). The techniques described herein combine all such different band combinations into a base band combination (e.g., a band combination identifier) that represents all five of the band combinations shown in the example illustrated above and included in FIG. 3 as a supported band combinations 305). However, it is to be understood that the number or quantity of band combinations supported by a UE may be more or less than the five band combinations shown in the supported band combinations 305 and the supported band combinations 305 is shown by way of example only.

The UE may transmit or otherwise output (and the network entity may receive or otherwise obtain) a UE capability message that carries or otherwise conveys an indication of or information associated with the band combination identifier. The band combination identifier may identify a plurality of band combinations supported by the UE (e.g., the supported band combinations 305, in this example) for wireless communications. For example, the band combination identifier may identify the supported band combinations 305 from some or all of the available band combinations. The band combination identifier may be based on or otherwise determined based on the sequential position of the uplink bands within each band combination of the plurality of band combinations. Each band combination may include a sequential listing (e.g., in order from first (the 0^{th} position) to the last band included in the band combination (the 4^{th} position in this example) of both the uplink bands and the downlink bands. Accordingly, the UE and the network entity may perform the wireless communications using one or more band combinations (e.g., one, some, or all of the bands in a band combination) of the plurality of band combinations supported by the UE according to the UE capability message. For example, the network entity may use the band combinations reported in the UE capability message for scheduling determinations related to the UE.

Broadly, the UE and the network entity may both capture or otherwise identify all the valid hovering uplink positions and map those uplink position coordinates (e.g., in a two-dimensional mapping, a three-dimensional mapping, etc.). The mapping may be based on the number of uplink bands in the band combination to a natural number. The band combination identifier may be identified, selected, or otherwise determined according to the mapping and the band combinations supported by the UE. The example shown in FIG. 3 includes the mapping being performed such that the set of integer values are associated with a matrix that is based on the quantity of available uplink band positions (six in this example) in the available band combinations. The matrix, in this example, corresponds to a 6×6 matrix and is shown as the table 310.

In this example shown in the supported band combinations 305 there may be five band combinations with six bands in each band combination. There are two uplink bands positioned within each band combination. As shown in the first supported band combination (e.g., the first row), the sequential order of the uplink bands can be found in the 0^{th} position and in the 4^{th} position (e.g., mapped to coordinates (0,4)). The remaining uplink bands in the supported band combinations 305 have uplink band positions that are mapped to (1,4), (3,4), (2,5), and (3,5). The UE may generate a table 310 (e.g., a 6×6 matrix in this example) that includes a set of unique integer values for each band combination in the available bands. The band combination identifier may include a set of integer values where each band combination in the plurality of band combinations is associated with a unique integer value in the set of integer values. The mapping of the uplink bands in each band combination may be applied to the table 310 to identify or otherwise determine the band combination identifier to be signaled to the network. The table 310 may also be generated by the network entity and used to read the band combination identifier signaled by the UE to identify the supported band combinations 305 that the UE supports. This may allow the UE to advertise (e.g., in the UE capability message) all the variants (e.g., the supported band combinations 305) of the base band combination within one band combination rather than advertising all of them individually. That is, all the base band combinations (e.g., the supported band combinations 305) may be represented by a list of natural numbers (e.g., unique integer values) of a given base band combination. In some aspects, the features of the uplink bands (e.g., 202, 203) are maintained in the band combination identifier.

More particularly, the mapping of each band combination into the table 310 may begin in a row first, column second manner. As one example, the third mapping (e.g., (3,4)) may begin by following the index column of the uplink band position down to row three and then going over in that row to column four. This intersection corresponds to the unique integer value of 19. This approach may be applied for each band combination in the supported band combinations 305 until the unique integer value of each band combination supported by the UE corresponds to a unique integer value. In this example, the band combination identifier 315 that is signaled to the network entity in the UE capability message is (4, 9, 19, 15, and 20).

Although the examples discussed above include two uplink bands in each band combination, it is to be understood that these techniques may be applied for band combinations having more than two uplink bands in each band combination. That is, these techniques of identifying the given uplink bands' positions and signaling the band combination identifier can be extended for more than two uplink bands. For example, if a UE supports three transmit chains and three receive chains, the band combinations supported by the UE may include three uplink bands in each band combination, the UE and the network entity may map the valid uplink band positions (e.g., the sequential positions) combination to a natural number according to Table 2 below.

TABLE 2

| (UL1 position, UL2 position, | Band Combination |
|---|---|
| UL3 position) | Identifier |
| (0, 0, 0) | X |
| (0, 0, 1) | X |
| . . . | . . . |
| (0, 1, 2) | 1 |
| (0, 1, 3) | 2 |
| (0, 1, 4) | 3 |
| (0, 2, 1) | 4 |
| (0, 2, 3) | 5 |
| (0, 2, 4) | 6 |
| . . . | . . . |

Table 2 illustrates an example where there are five bands in each band combination with three uplink bands per-band combination. As one example, a band combination supported by the UE may include: n1AA [1×50]+n2A+n5AA [1×30]+n7A+n41AA [1×100]+n78A. In this example, the uplink band n1AA corresponds to the first uplink band (UL1) having a 50 MHz channel bandwidth. The uplink band n5AA corresponds to the second uplink band (UL2) having a 30 MHz channel bandwidth. The uplink band n41AA corresponds to the third uplink band (UL3) having a 100 MHz channel bandwidth. The uplink positions can be inferred from the coordinates (0,2,4). That is, the mapping (0,2,4) signals that the first uplink band is the 0^{th} band, the second uplink band is the 2nd band, and the third uplink band is the 4^{th} band in the band combination. According to Table 2, this band combination is mapped to the unique integer value “6” that is included in the band combination identifier signaled to the network in the UE capability message. As discussed above, only valid entries in Table 2 are mapped to an integer value while non-valid entries are mapped to X (e.g., not a valid uplink band position). This is because two uplink bands cannot occupy the same sequential position within a band combination.

Accordingly, in some aspects the band combination identifier may be based on a number or quantity of bands in the plurality of band combinations supported by the UE and a number of uplink bands in each band combination. Given a maximum number of bands (e.g., N bands) in each band combination and a number (e.g., U) of uplink bands in each band combination, the techniques described herein may be based on an algorithm that can output the possible valid permutations of the uplink positions that can reside one those bands in a non-repetitive manner. That is, the algorithm may be used to generate the set of unique integer values for each band combination in the available band combinations.

For example, the UE may advertise two band combinations that include two different band combination pairs (e.g., a different number of uplink bands and a maximum number of bands for the given number of uplink bands). As one example, the UE may advertise a first band combination (BC1) that includes five band combinations with two uplink bands per band combination and a second band combination (BC2) that includes seven band combinations with four uplink bands per band combination. In this example, the algorithm may be performed or otherwise implemented for both of the above variants (e.g., BC1 and BC2) as the (N, U) pair for both the above combinations are different. Accordingly, the number of valid non-repetitive permutations of those uplink band positions would change. Thus, the band combination identifier (e.g., the BandCombinationID) which represents the given band combination would change for each of BC1 and BC2.

With BC1 the N=5 and U=2 such that the BandCombinationID ‘8’ may correspond to (1, 4) permutation, which signals that the first uplink band on or at the 2^{nd} band position and the second uplink band is on or at 4^{th} band of the band combination. However, the same BandCombinationID ‘8’ used in BC2 where N=7 and U=4 would refer to (0, 1, 3, 6) where first uplink band is on or at the 0^{th} sequential position, the second uplink band is on or at the 1^{st} sequential position, the third uplink band is on or at the 3^{rd} sequential position, and the fourth uplink band is on or at the 6^{th} sequential position within the band combination. Accordingly, the UE and the network entity may maintain these tables that maps uplink band positions and the band combination identifier s for every advertised BC (e.g., for each combination of N and U advertised by the UE. In the example above, this may include the UE and the network entity maintaining tables for the set of unique integer values for each band combination in the available band combinations (e.g., a table for five band combinations with two uplink bands per band combination and another table for seven band combinations with four uplink bands per band combination).

One such example of a first algorithm that may be used to generate the table, matrix, etc., for the set of unique integer values for each band combination in the available bands is shown below. The band combination identifier that is signaled to the network in the UE capability message may be based on the output of this algorithm.

```
FUNCTION validUplinkCombination(n, k, depth, current, used, id):
  IF depth == k THEN
    PRINT “ID ”, id, “: ”, current array
    INCREMENT id
    RETURNA[4]
  END IF
  FOR i = 0 TO n − 1 DO
    IF used[i] IS FALSE THEN
      SET used[i] TO TRUE
      SET current[depth] TO i
      CALL validUplinkCombination (n, k, depth + 1, current, used, id)
      SET used[i] TO FALSE
    END IF
  END FOR
END FUNCTION
MAIN:
  SET n = 7 // Total number of elements
  SET k = 4 // Number of places to fill
  INITIALIZE current[k]
  INITIALIZE used[n]TO FALSE
  SET id = 1 // Initialize the ID counter
  CALL validUplinkCombination (n, k, 0, current, used, id)
END MAIN
```

This algorithm may be used to generate all valid band combinations identifiers (e.g., the valid uplink band position permutations) for a given number of uplink bands (e.g., U) on the number of band combinations (e.g., N). In an example where N=7 (e.g., seven band combinations) and U=2 (e.g., two uplink bands per band combination), the output of the algorithm may include ID 1: (0 1), ID 2: (02), ID 3: (0 3), ID 4: (04), ID 5: (1 0), ID 6: (1 2), ID 7: (1 3), ID 8: (1 4), and ID 9: (2 0).

A second algorithm that may be used to generate (or recover) the band combination identifier based on or otherwise associated with the number of bands in the plurality of band combinations supported by the UE and the number of uplink bands in each band combination is shown below. This second algorithm may be used to generate the band combination identifier (BandCombinationID) for a given valid uplink band positions permutation and for a given number of uplink bands (e.g., U) based on the number of band combinations (e.g., N).

```
FUNCTION calculateBC_ID(n, k, permutation):
  INITIALIZE available[n] with TRUE
  id = 0
  FOR i = 0 TO k − 1 DO
    count = 0
    FOR j = 0 TO permutation[i] − 1 DO
      IF available[j] IS TRUE THEN
        count = count + 1
      END IF
    END FOR
    id = id + count * (Factorial(n − i − 1) / Factorial(n − k))
    available[permutation[i]] = FALSE
  END FOR
  RETURN id + 1
END FUNCTION
MAIN:
  n = 7 // Total number of elements
  k = 4 // Number of places to fill
  permutation = [6, 4, 2, 0] // The permutation to find the ID for
  id = calculateBC_ID (n, k, permutation)
  PRINT “The ID of the permutation { ”
  FOR i = 0 TO k − 1 DO
    PRINT permutation[i] + “ ”
  END FOR
  PRINT “ } is: ”, id
END MAIN
```

In an example for a given number of band combinations (e.g., N=7) and uplink bands per band combination (e.g., U=4), the identifier of the permutation {6 4 2 0] may correspond to 809. In an example for a given number of band combinations (e.g., N=5) and uplink bands per band combination (e.g., U=2), the identifier of the permutation {3 2} may correspond to 15.

Accordingly, in some aspects the UE may transmit or otherwise output (and the network entity may receive or otherwise obtain) signaling that carries or otherwise conveys information identifying or indicating a number of band combinations (e.g., N) included in the plurality of band combinations supported by the UE, the number of uplink bands in each band combination (e.g., U), or both. This information or indication may be provided in the UE capability message or in other signaling or messages that are separate from the UE capability signaling.

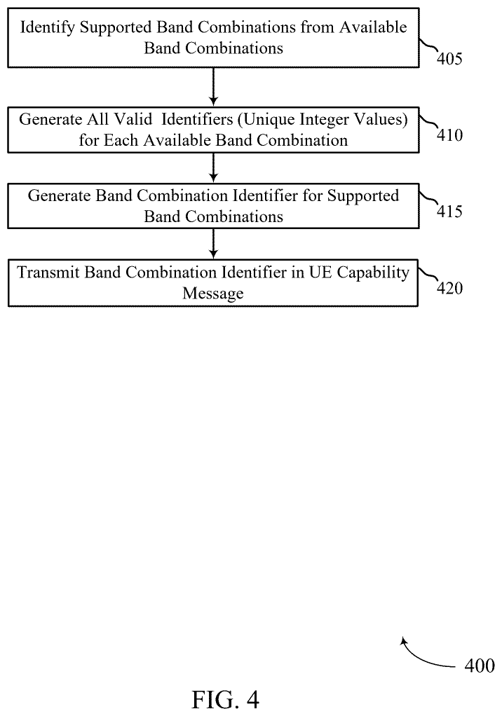

FIG. 4 shows an example of a method 400 that supports UE capability information signaling in accordance with one or more aspects of the present disclosure. Aspects of the method 400 may implement or be implemented by aspects of the wireless communications system 100 or the wireless communications system 200 or aspects of the algorithm 300. For example, aspects of the method 400 may be implemented at or implemented by a UE or a network entity, which may be examples of the corresponding devices described herein.

At 405, the UE may identify or otherwise determine the band combinations supported by the UE from the available band combinations. For example, the UE may may identify the supported band combinations based on various capabilities, functions, or communication types associated with the UE. As one example, the UE may identify the supported band combinations based on the number of concurrent or simultaneous uplink transmissions the UE can perform (e.g., the number of transmit chains). As another example, the UE may identify the supported band combinations based on the type of UE (e.g., based on whether the UE is a reduced capability (RedCap) UE, an IoT UE, or other UE type). The UE type may indicate the nature of the communication types the UE will perform (e.g., uplink only, uplink-heavy, downlink only, downlink-heavy, etc.).

At 410, the UE (and the network entity) may generate all valid identifiers (e.g., unique integer values) for each available band combination. In some aspects, the UE may use the first algorithm discussed above to generate the set of unique integer values for each band combination in the available band combinations. For example, the UE (and the network entity) may use the first algorithm to generate a table or matrix that includes a mapping or index of uplink band positions for each band combination to natural numbers.

At 415, the UE (and the network entity) may generate the band combination identifier for the band combinations supported by the UE. In some aspects, the UE may use the second algorithm discussed above to generate (and the network entity may use the second algorithm to recover) the unique integer values corresponding to each band combination in the supported band combinations. For example, the UE (and the network entity) may use the second algorithm to generate a table or matrix that includes a mapping or index of uplink band positions for each band combination to natural numbers. The natural numbers (e.g., the band combination identifier) signaled to the network in the UE capability signaling may be used by the network entity (e.g., based on the second algorithm) to identify the band combinations supported by the UE. These supported band combinations may be used by the UE and the network entity for wireless communications (e.g., one, some, or all of the band communications supported by the UE).

At 420, the UE may transmit or otherwise output (and the network entity may receive or otherwise obtain) the UE capability message that includes the band combination identifier. Aspects of the techniques described herein provide for signaling relating to the UE capability signaling. In some cases, the UE capability message may carry or otherwise convey an indication of a band combination parameter that indicates the band combination identifier. In some cases, the UE capability message may carry or otherwise convey an indication of a first information element that identifies a number of band combinations and second information element that identifies a number of uplink bands in each band combination. In some cases, the UE capability message may carry or otherwise convey an indication of a number of band combinations included in the plurality of band combinations supported by the UE. In some cases, the UE capability message may carry or otherwise convey an indication of a number of uplink bands in each band combination supported by the UE.

As one example, the UE may report two sets of band combinations (e.g., BC1 and BC2) where BC1 is a frequency and time uplink CA combination and BC2 is a frequency and frequency uplink CA combination. In other networks, the UE would report these supported band combinations separately (e.g., as 10 different band combinations. The BC1 may correspond to:

$$n 1 AA [ 1 \times 50 ] + n 2 A + n 5 A + n 7 A + n 41 AA [ 1 \times 100 ] + n 78 A ( 0 , 4 ) \to 4$$

$$n 1 A + n 2 AA [ 1 \times 50 ] + n 5 A + n 7 A + n 41 AA [ 1 \times 100 ] + n 78 A ( 1 , 4 ) \to 9$$

$$n 1 A + n 2 A + n 5 A + n 7 AA [ 1 \times 50 ] + n 41 AA [ 1 \times 100 ] + n 78 A ( 3 , 4 ) \to 19$$

$$n 1 A + n 2 A + n 5 AA [ 1 \times 50 ] + n 7 A + n 41 A + n 78 AA [ 1 \times 100 ] ( 2 , 5 ) \to 15$$

$$n 1 A + n 2 A + n 5 A + n 7 AA [ 1 \times 50 ] + n 41 A + n 78 AA [ 1 \times 100 ] ( 3 , 5 ) \to 20$$

Accordingly, BC1 may correspond to a set of uplink shifted variants covering frequency and time uplink CA cases. In BC1, the frequency spectrum uplink identifier ‘202’ may correspond to the 50 MHz channel bandwidth and the frequency spectrum uplink identifier ‘203’ may correspond to the 100 MHz channel bandwidth. That is, the order of the uplink bands may be represented as (202,203) in this example band combination.

The BC2 may correspond to:

$$n 1 AA [ 1 \times 40 ] + n 2 A + n 5 AA [ 1 \times 10 ] + n 7 A + n 41 A + n 78 A : ( 1 , 3 ) \to 8$$

$$n 1 A + n 2 AA [ 1 \times 10 ] + n 5 AA [ 1 \times 40 ] + n 7 A + n 41 A + n 78 A : ( 2 , 1 ) \to 12$$

$$n 1 AA [ 1 \times 10 ] + n 2 AA [ 1 \times 40 ] + n 5 A + n 7 A + n 41 A + n 78 A : ( 1 , 0 ) \to 6$$

$$n 1 A + n 2 A + n 5 AA [ 1 \times 40 ] + n 7 AA [ 1 \times 10 ] + n 41 A + n 78 A : ( 2 , 3 ) \to 13$$

$$n 1 AA [ 1 \times 10 ] + n 2 A + n 5 A + n 7 AA [ 1 \times 40 ] + n 41 A + n 78 A : ( 3 , 0 ) \to 16$$

Accordingly, BC2 may correspond to a set of uplink shifted variants covering frequency and frequency uplink CA cases. In BC2, the frequency spectrum uplink identifier ‘115’ may correspond to 10 MHz channel bandwidth and the frequency spectrum uplink identifier ‘116’ may correspond to the 40 MHz channel bandwidth. That is, the order of the uplink bands may be represented as (116,115) in this example band combination.

As discussed, some networks may include the UE reporting 10 separate band combinations being supported to the network. However, the techniques described herein may map the sequential position of the uplink bands in each band combination to a natural number (e.g., a unique integer value) that is representative of the band combination. The natural numbers corresponding to the supported band combinations may be reported to the network entity as a band combination identifier. For BC1, the band combination identifier may correspond to (4, 9, 19, 15, 20). For BC2, the band combination identifier may correspond to (8, 12, 6, 13, 16). As discussed, these natural numbers may be based on the sequential listing or order of the uplink bands in each band combination (e.g., (0,4), (1,4), (3,4), etc.).

In some aspects, the UE capability message may include a UE-NR-Capability field with at least an rf-Parameters subfield. The rf-Parameters subfield may include at least a BandCombination subfield that includes bandList subfield. The bandList subfield may include a set of BandParameters (e.g., BandParameters [0] through BandParameters [5]) as well as a featureSetCombination parameter (e.g., set to [0]). In this example, the BandParameters [0] may be representative of BC1 discussed above and the BandParameters [4] may be representative of BC2.

The UE capability message may also include a featureSetCombinations field that includes at least one FeatureSetsPerBand subfield. The FeatureSetsPerBand subfield may include at least one FeatureSet subfield. In this example, the FeatureSet subfield [0] (e.g., associated with BC1) there may be an uplinkSetNR parameter that is set to a value of one. In this example, the FeatureSet subfield [4] (e.g., associated with BC2) there may be an uplinkSetNR parameter that is set to a value of four. Accordingly, the signaling in this example may include the base band combination n1AA [1×50]+n2A+n5A+n7A+n41AA [1×100]+n78A which combines in BC1 may be represented similar to reporting a band combination. On top of the base band combination, a new extension (e.g., a BandCombination V1810 extension) may be used the UE may report a BandCombinationID for all the uplinks band hovering variants which may represent all of the band combinations in given set.

In some aspects, this may include the UE advertising these Set-1, Set-2 (e.g., BC1 and BC2) together into ‘2’ merged band combinations using a style of signaling that will save space in the ‘supportedBandCombinationList’ parameter. The abstract syntax notation one (ASN1) elements representing an uplinkHoveringPositionsSet parameter or information may be included as a v1810 extension. The v1810 extension may correspond to:

```
BandCombination-v1810 ::= SEQUENCE {
  uplinkHoveringPositionsSet SEQUENCE
    (SIZE (1..maxUplinkHoveringPositonsSets) )
      OF UplinkHoveringPositions OPTIONAL
}
UplinkHoveringPositions ::= SEQUENCE {
  numOfMergedBandCombinations INTEGER (1..1024),
  -- Depend on the number of ULs in the band combination
  bandCombinationIDList SEQUENCE
    (SIZE (1..maxNumOfMergedBandCombinations))
      OF INTEGER (1..1024)
}
maxNumOfMergedBandCombinations INTEGER ::= 1024 --
Maximum number of Band combinations which are uplink variations
maxUplinkHoveringPositonsSets INTEGER::= 128 -- (for NR)
```

The number of uplink band hovering positions sets that a given band combination can have may be consistent with the maximum number of feature sets per band.

Accordingly, the UE capability message may include a supportedBandCombinationList field that includes a listing of BandCombinations being reported (e.g., BandCombination [0] and BandCombination [1] in this example). The UE capability message may also include an <extenstion-group-20> field that includes a supportedBandCombinationList-v1810 subfield (e.g., the 1810 extension). The supportedBandCombinationList-v1810 subfield may include a BandComination-v1810 subfield that is associated with each BC (e.g., a BandCombination-v1810 [0] corresponding to BC1 and a BandCombination-v1810 [1] corresponding to BC2). Each BandCombination-v1810 subfield may include an uplinkHoveringPositionSet subfield that includes a corresponding UplinkHoveringPositions subfield. For each BC, the UplinkHoveringPositions subfield may include a numOfMergedBandCombinations parameter that identifies how many band combinations are included in the plurality of band combinations supported by the UE. the UplinkHoveringPositions subfield may also include a bandCombinationIDList that includes a set of natural numbers corresponding to the band combinations being supported in this BandCombination-v1810 entry.

For BC1, in the UplinkHoveringPositions [0] of the BandCombination-v1810 [0] subfield the numOfMergedBandCombinations may be set to a value of five and the bandCombinationIDList may include an INTEGER [0] set to 4, an INTEGER [1] set to nine, an INTEGER [2] set to nineteen, an INTEGER [3] set to fifteen, and an INTEGER [4] set to twenty. Thus, the band combination identifier corresponding to BC1 from the example above (e.g., (4, 9, 19, 15, 20)) may be signaled in the UE capability message.

For BC2, in the UplinkHoveringPositions [0] in the BandCombination-v1810 [1] subfield the numOfMergedBandCombinations may be set to a value of five and the bandCombinationIDList may include an INTEGER [0] set to eight, an INTEGER [1] set to twelve, an INTEGER [2] set to six, an INTEGER [3] set to thirteen, and an INTEGER [4] set to sixteen. Thus, the band combination identifier corresponding to BC2 from the example above (e.g., (8, 12, 6, 13, 16)) may be signaled in the UE capability message.

Thus, the signaling techniques described herein are applicable for any number of uplink bands. For a one uplink band scenario, the uplink band position would be same as the band index starting from ‘0’. Application of these techniques may be provided in an example of two sets. The two sets may include ten combinations that can be merged into two combinations by capturing the uplink hovering positions in the ‘supportedBandCombinationList.’ This may result in a savings of more than 60% of the original space that is used to fill in ten whole band combinations. For example, to fit ten band combinations may use 3702 bits, which covers the ‘supportedBandCombinationList’ and the associated ‘featureSets’ according to some wireless networks. However, fitting these two new style of merged band combinations that represents two sets (BC1, BC2) with the uplink hovering position extensions may use only 1191 bits. These techniques of UE capability signaling may save around two thirds of the original space, which may be used to fit in more numbers of band combinations which in turn may represents 20+ more band combinations that can be reported in the UE capability signaling.

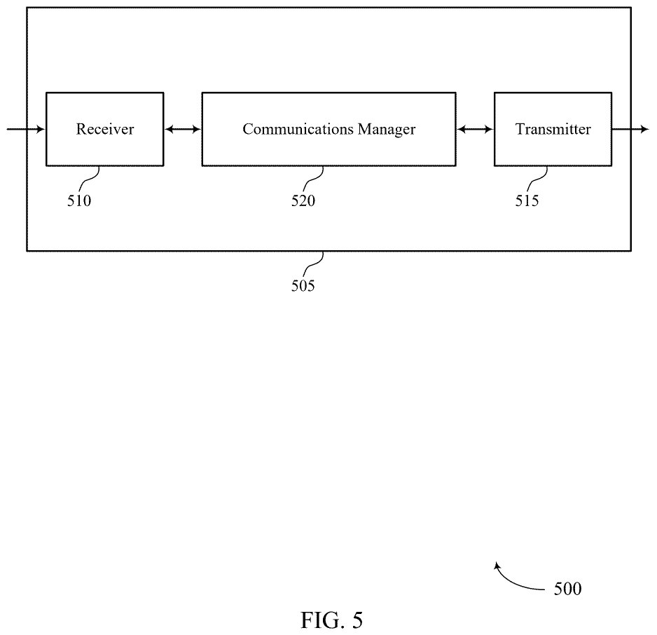

FIG. 5 shows a block diagram 500 of a device 505 that supports UE capability information signaling in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to UE capability information signaling). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to UE capability information signaling). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of UE capability information signaling as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The communications manager 520 is capable of, configured to, or operable to support a means for performing the wireless communications using one or more band combinations of the set of multiple band combinations supported by the UE in accordance with the UE capability message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for UE capability signaling by mapping the sequential position of uplink bands in a band combination to natural numbers and reporting those numbers in the UE capability signaling to identify the band combinations supported by the UE (e.g., in a band combination identifier).

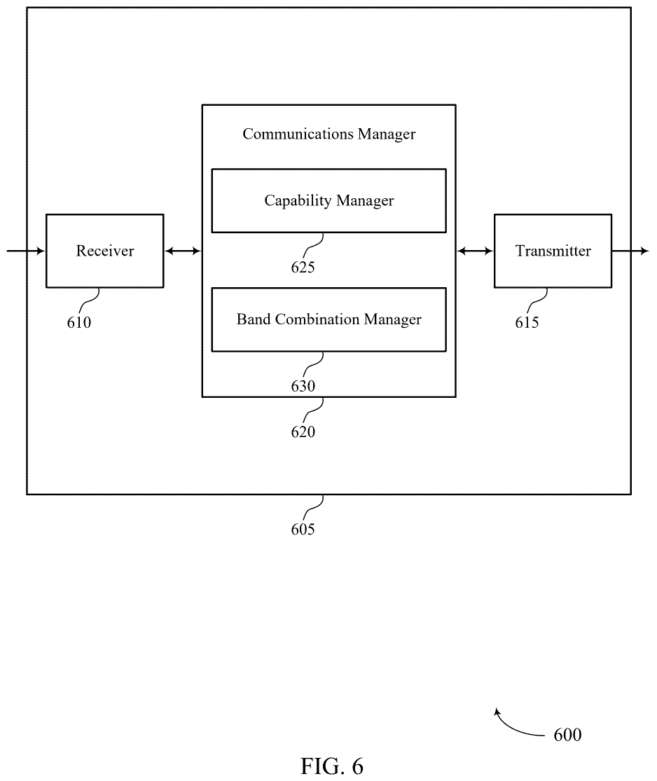

FIG. 6 shows a block diagram 600 of a device 605 that supports UE capability information signaling in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to UE capability information signaling). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to UE capability information signaling). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of UE capability information signaling as described herein. For example, the communications manager 620 may include a capability manager 625 a band combination manager 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The capability manager 625 is capable of, configured to, or operable to support a means for transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The band combination manager 630 is capable of, configured to, or operable to support a means for performing the wireless communications using one or more band combinations of the set of multiple band combinations supported by the UE in accordance with the UE capability message.

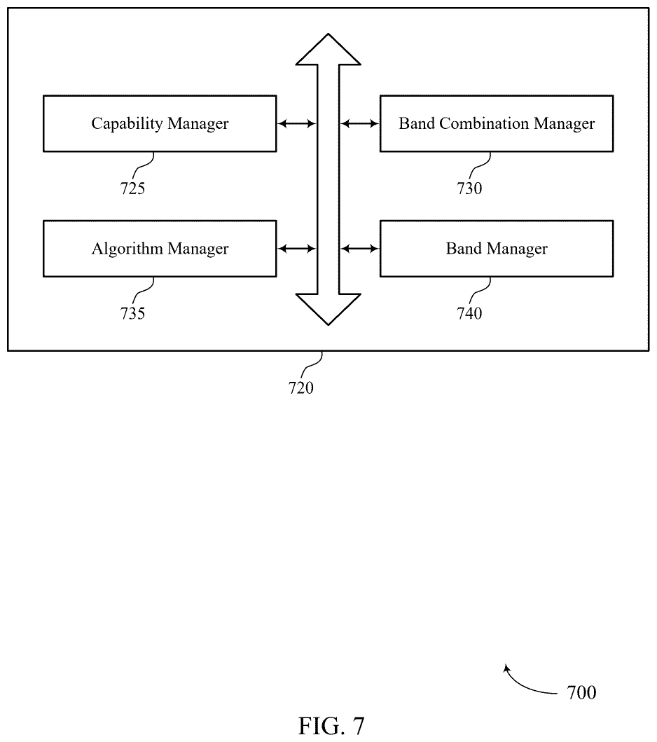

FIG. 7 shows a block diagram 700 of a communications manager 720 that supports UE capability information signaling in accordance with one or more aspects of the present disclosure. The communications manager 720 may be an example of aspects of a communications manager 520, a communications manager 620, or both, as described herein. The communications manager 720, or various components thereof, may be an example of means for performing various aspects of UE capability information signaling as described herein. For example, the communications manager 720 may include a capability manager 725, a band combination manager 730, an algorithm manager 735, a band manager 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The capability manager 725 is capable of, configured to, or operable to support a means for transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The band combination manager 730 is capable of, configured to, or operable to support a means for performing the wireless communications using one or more band combinations of the set of multiple band combinations supported by the UE in accordance with the UE capability message.

In some examples, the algorithm manager 735 is capable of, configured to, or operable to support a means for providing that the band combination identifier includes a set of integer values, where each band combination in the plurality of band combinations are associated with a unique integer in the set of integer values. In some examples, the algorithm manager 735 is capable of, configured to, or operable to support a means for receiving a table that identifies a set of integer values for each band combination in available band combinations, where the band combination identifier is associated with the table.

In some examples, each unique integer value may correspond to a sequential position of uplink bands in each band combination. In some examples, the set of integer values are associated with a matrix, the matrix based on a quantity of available uplink band positions in available band combinations. In some examples, the band combination identifier is associated with a number of concurrent uplink communications supported by the UE. In some examples, the band combination identifier is associated with a number of bands in the set of multiple band combinations supported by the UE and a number of uplink bands in each band combination.

In some examples, the band manager 740 is capable of, configured to, or operable to support a means for generating, according to a first algorithm, a set of unique integer values for each band combination in the available band combinations, where the band combination identifier is based on the set of unique integer values.

In some examples, the band manager 740 is capable of, configured to, or operable to support a means for generating, according to a second algorithm, the band combination identifier based on the number of bands in the set of multiple band combinations supported by the UE and the number of uplink bands in each band combination. In some examples, the UE capability message includes a band combination parameter that indicates the band combination identifier. In some examples, the UE capability message includes a first information element that identifies a number of band combinations and second information element that identifies a number of uplink bands in each band combination. In some examples, the UE capability message includes an indication of a number of band combinations included in the set of multiple band combinations supported by the UE.

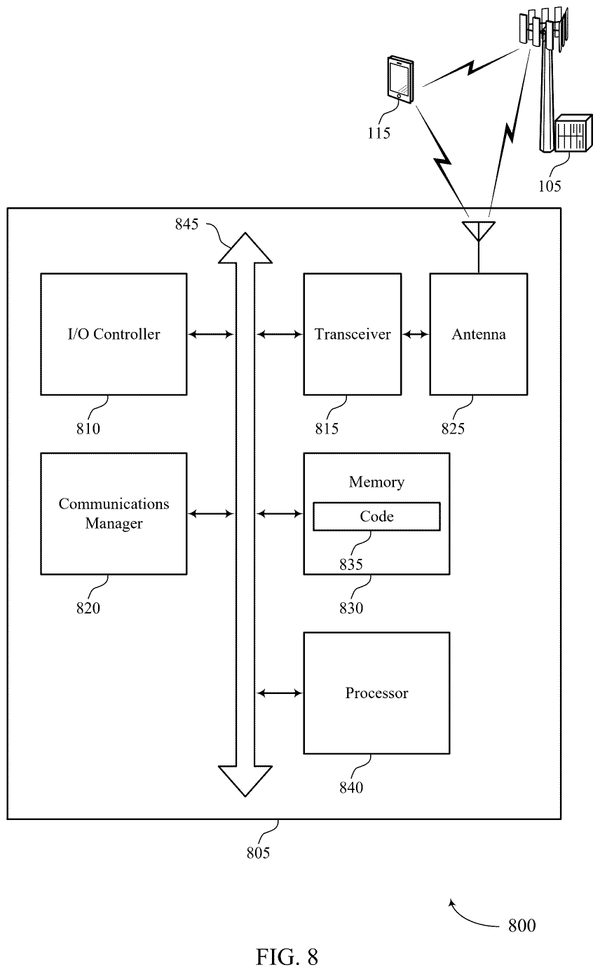

FIG. 8 shows a diagram of a system 800 including a device 805 that supports UE capability information signaling in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting UE capability information signaling). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The communications manager 820 is capable of, configured to, or operable to support a means for performing the wireless communications using one or more band combinations of the set of multiple band combinations supported by the UE in accordance with the UE capability message.

By including or configuring the communications manager 820 in accordance with examples as described herein, the device 805 may support techniques for UE capability signaling by mapping the sequential position of uplink bands in a band combination to natural numbers and reporting those numbers in the UE capability signaling to identify the band combinations supported by the UE (e.g., in a band combination identifier).

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of UE capability information signaling as described herein, or the at least one processor 840 and the at least one memory 830 may be otherwise configured to, individually or collectively, perform or support such operations.

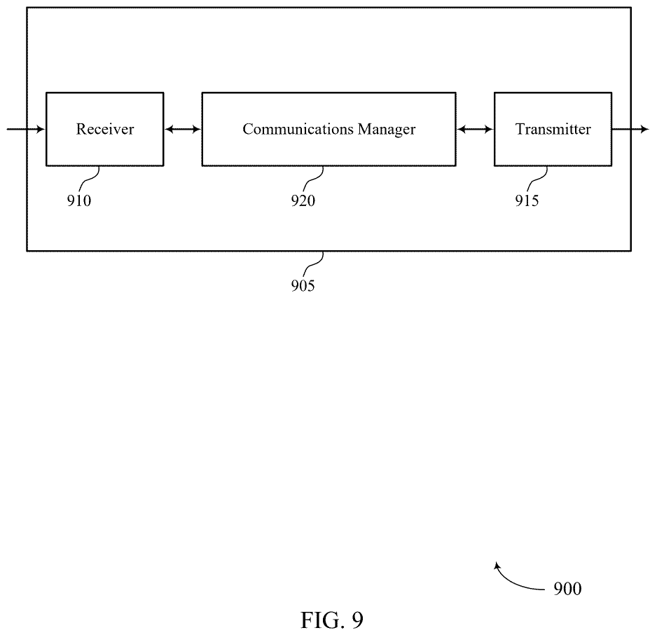

FIG. 9 shows a block diagram 900 of a device 905 that supports UE capability information signaling in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of UE capability information signaling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The communications manager 920 is capable of, configured to, or operable to support a means for performing the wireless communications with the UE using one or more band combinations of the set of multiple band combinations supported by the UE in accordance with the UE capability message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for UE capability signaling by mapping the sequential position of uplink bands in a band combination to natural numbers and reporting those numbers in the UE capability signaling to identify the band combinations supported by the UE (e.g., in a band combination identifier).

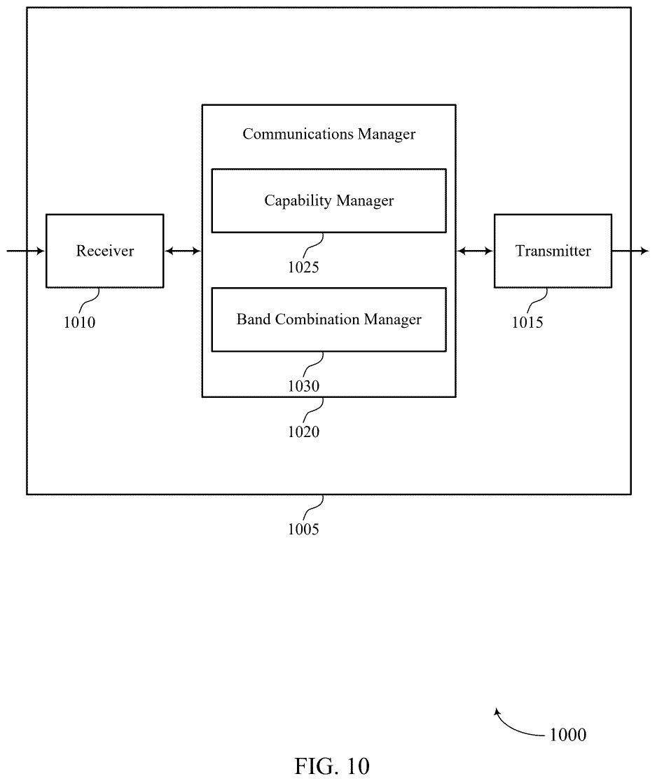

FIG. 10 shows a block diagram 1000 of a device 1005 that supports UE capability information signaling in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of UE capability information signaling as described herein. For example, the communications manager 1020 may include a capability manager 1025 a band combination manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The capability manager 1025 is capable of, configured to, or operable to support a means for receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The band combination manager 1030 is capable of, configured to, or operable to support a means for performing the wireless communications with the UE using one or more band combinations of the set of multiple band combinations supported by the UE in accordance with the UE capability message.

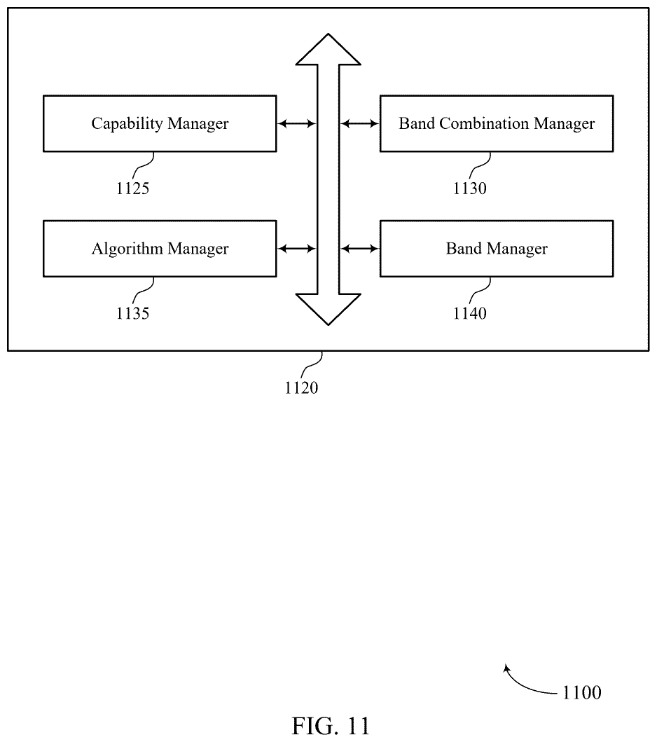

FIG. 11 shows a block diagram 1100 of a communications manager 1120 that supports UE capability information signaling in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of UE capability information signaling as described herein. For example, the communications manager 1120 may include a capability manager 1125, a band combination manager 1130, an algorithm manager 1135, a band manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The capability manager 1125 is capable of, configured to, or operable to support a means for receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The band combination manager 1130 is capable of, configured to, or operable to support a means for performing the wireless communications with the UE using one or more band combinations of the set of multiple band combinations supported by the UE in accordance with the UE capability message.

In some examples, the algorithm manager 1135 is capable of, configured to, or operable to support a means for providing for the band combination identifier including a set of integer values, where each band combination in the plurality of band combinations is associated with a unique integer in the set of integer values. In some examples, the algorithm manager 1135 is capable of, configured to, or operable to support a means for transmitting a table that identifies a set of integer values for each band combination in available band combinations, wherein the band combination identifier is associated with the table.

In some examples, each unique integer may correspond to a sequential position of uplink bands in each band combination. In some examples, the set of integer values are associated with a matrix, the matrix based on a quantity of available uplink band positions in available band combinations. In some examples, the band combination identifier is associated with a number of concurrent uplink communications supported by the UE. In some examples, the band combination identifier is associated with a number of bands in the set of multiple band combinations supported by the UE and a number of uplink bands in each band combination.

In some examples, the band manager 1140 is capable of, configured to, or operable to support a means for generating, according to a first algorithm, a set of unique integer values for each band combination in the available band combinations, where the band combination identifier is based on the set of unique integer values. In some examples, the band combination identifier is based on the number of bands in the set of multiple band combinations supported by the UE and the number of uplink bands in each band combination. In some examples, the UE capability message includes a band combination parameter that indicates the band combination identifier. In some examples, the UE capability message includes a first information element that identifies a number of band combinations and second information element that identifies a number of uplink bands in each band combination. In some examples, the UE capability message includes an indication of a number of band combinations included in the set of multiple band combinations supported by the UE.

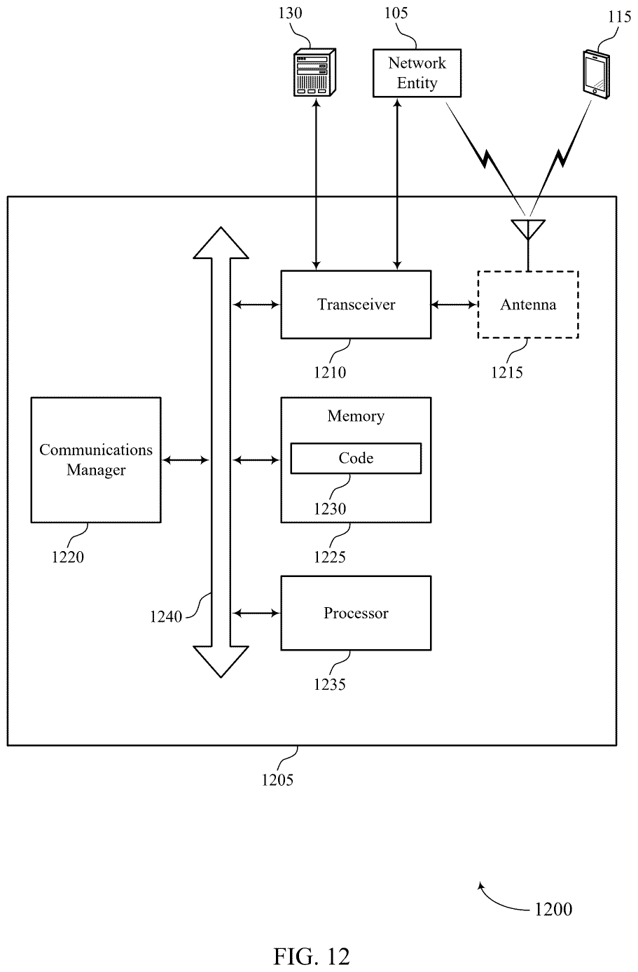

FIG. 12 shows a diagram of a system 1200 including a device 1205 that supports UE capability information signaling in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting UE capability information signaling). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The communications manager 1220 is capable of, configured to, or operable to support a means for performing the wireless communications with the UE using one or more band combinations of the set of multiple band combinations supported by the UE in accordance with the UE capability message.

By including or configuring the communications manager 1220 in accordance with examples as described herein, the device 1205 may support techniques for UE capability signaling by mapping the sequential position of uplink bands in a band combination to natural numbers and reporting those numbers in the UE capability signaling to identify the band combinations supported by the UE (e.g., in a band combination identifier).

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of UE capability information signaling as described herein, or the at least one processor 1235 and the at least one memory 1225 may be otherwise configured to, individually or collectively, perform or support such operations.

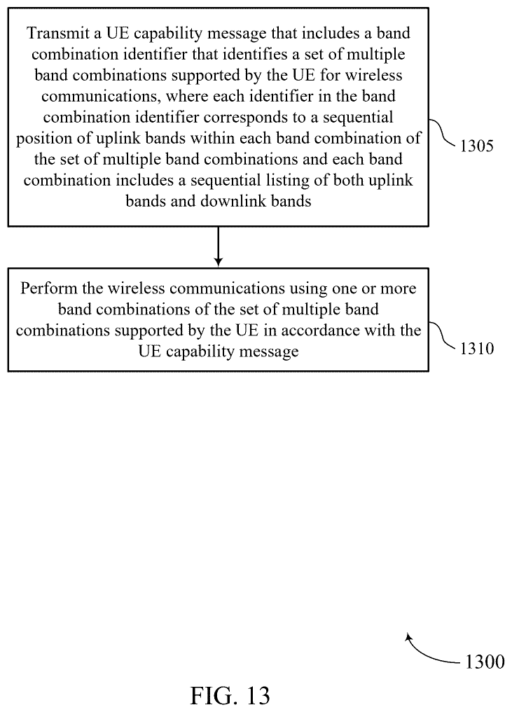

FIG. 13 shows a flowchart illustrating a method 1300 that supports UE capability information signaling in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The operations of 1305 may be performed in accordance with examples as disclosed herein. In some examples, aspects of the operations of 1305 may be performed by a capability manager 725 as described with reference to FIG. 7.

At 1310, the method may include performing the wireless communications using one or more band combinations of the set of multiple band combinations supported by the UE in accordance with the UE capability message. The operations of 1310 may be performed in accordance with examples as disclosed herein. In some examples, aspects of the operations of 1310 may be performed by a band combination manager 730 as described with reference to FIG. 7.

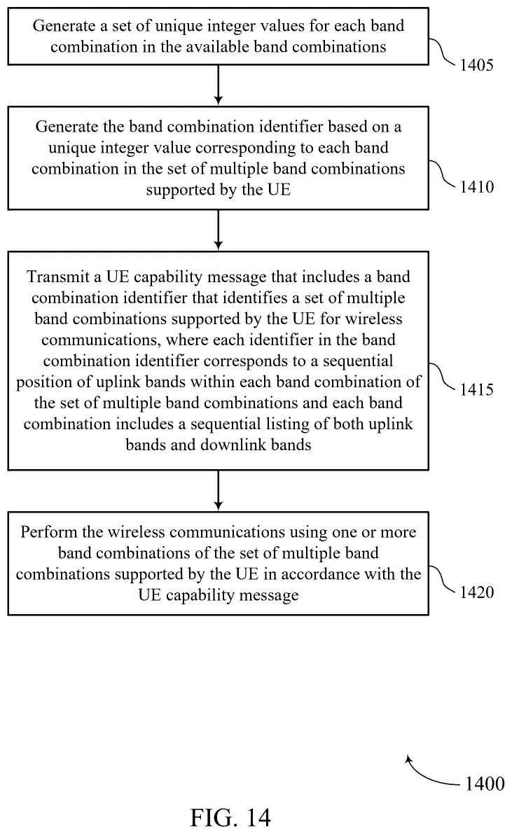

FIG. 14 shows a flowchart illustrating a method 1400 that supports UE capability information signaling in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include generating a set of unique integer values for each band combination in the available band combinations. In some cases, the band combination identifier may include a set of integer values. The operations of 1405 may be performed in accordance with examples as disclosed herein. In some examples, aspects of the operations of 1405 may be performed by an algorithm manager 735 as described with reference to FIG. 7.

At 1410, the method may include generating the band combination identifier based on a unique integer value corresponding to each band combination in the set of multiple band combinations supported by the UE. In some cases, each band combination in the plurality of band combinations may be associated with a unique integer in the set of integer values. The operations of 1410 may be performed in accordance with examples as disclosed herein. In some examples, aspects of the operations of 1410 may be performed by an algorithm manager 735 as described with reference to FIG. 7.

At 1415, the method may include transmitting a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The operations of 1415 may be performed in accordance with examples as disclosed herein. In some examples, aspects of the operations of 1415 may be performed by a capability manager 725 as described with reference to FIG. 7.

At 1420, the method may include performing the wireless communications using one or more band combinations of the set of multiple band combinations supported by the UE in accordance with the UE capability message. The operations of 1420 may be performed in accordance with examples as disclosed herein. In some examples, aspects of the operations of 1420 may be performed by a band combination manager 730 as described with reference to FIG. 7.

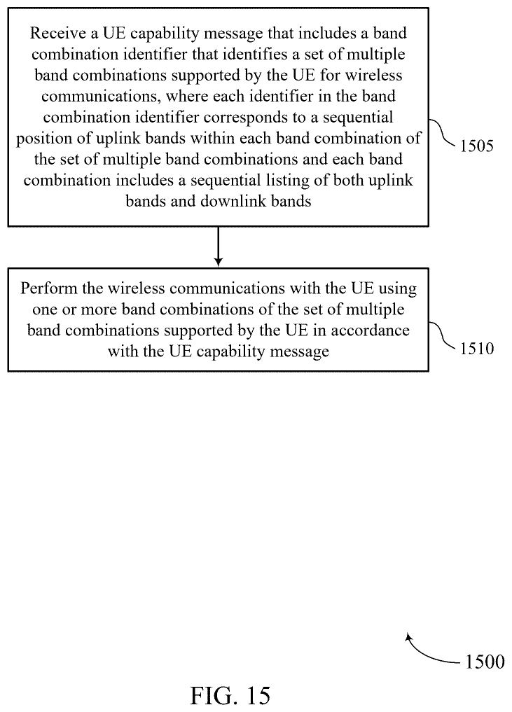

FIG. 15 shows a flowchart illustrating a method 1500 that supports UE capability information signaling in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The operations of 1505 may be performed in accordance with examples as disclosed herein. In some examples, aspects of the operations of 1505 may be performed by a capability manager 1125 as described with reference to FIG. 11.

At 1510, the method may include performing the wireless communications with the UE using one or more band combinations of the set of multiple band combinations supported by the UE in accordance with the UE capability message. The operations of 1510 may be performed in accordance with examples as disclosed herein. In some examples, aspects of the operations of 1510 may be performed by a band combination manager 1130 as described with reference to FIG. 11.

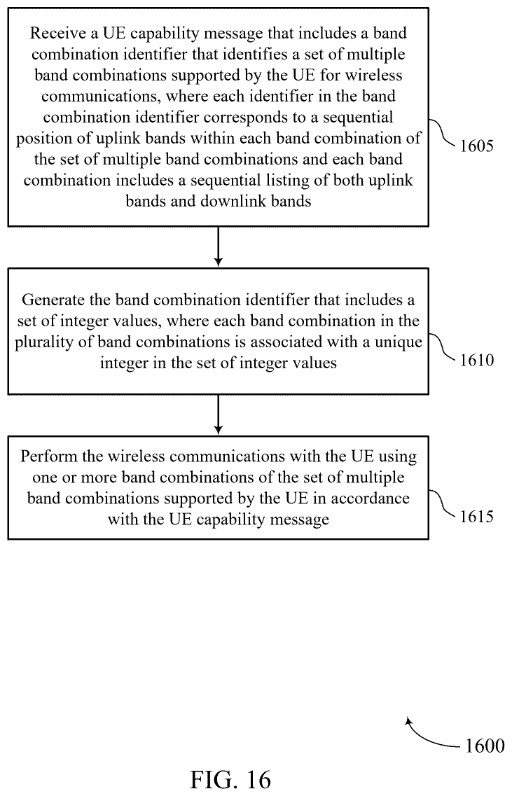

FIG. 16 shows a flowchart illustrating a method 1600 that supports UE capability information signaling in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a UE capability message that includes a band combination identifier that identifies a set of multiple band combinations supported by the UE for wireless communications, where each identifier in the band combination identifier corresponds to a sequential position of uplink bands within each band combination of the set of multiple band combinations and each band combination includes a sequential listing of both uplink bands and downlink bands. The operations of 1605 may be performed in accordance with examples as disclosed herein. In some examples, aspects of the operations of 1605 may be performed by a capability manager 1125 as described with reference to FIG. 11.

At 1610, the method may include generating the band combination identifier that includes a set of integer values, where each band combination in the plurality of band combinations is associated with a unique integer in the set of integer values. The operations of 1610 may be performed in accordance with examples as disclosed herein. In some examples, aspects of the operations of 1610 may be performed by an algorithm manager 1135 as described with reference to FIG. 11.

At 1615, the method may include performing the wireless communications with the UE using one or more band combinations of the set of multiple band combinations supported by the UE in accordance with the UE capability message. The operations of 1615 may be performed in accordance with examples as disclosed herein. In some examples, aspects of the operations of 1615 may be performed by a band combination manager 1130 as described with reference to FIG. 11.

The following provides an overview of aspects of the present disclosure:

Aspect 1: A method for wireless communications at a UE, comprising: transmitting a UE capability message that comprises a band combination identifier that identifies a plurality of band combinations supported by the UE for wireless communications, wherein each identifier in the band combination identifier corresponds to a sequential position of uplink bands within each band combination of the plurality of band combinations and each band combination comprises a sequential listing of both uplink bands and downlink bands; and performing the wireless communications using one or more band combinations of the plurality of band combinations supported by the UE in accordance with the UE capability message.

Aspect 2: The method of aspect 1, wherein the band combination identifier comprises a set of integer values, and each band combination in the plurality of band combinations is associated with a unique integer in the set of integer values.

Aspect 3: The method of aspect 2, wherein each unique integer corresponds to a sequential position of uplink bands in each band combination.

Aspect 4: The method of any of aspects 2 through 3, wherein the set of integer values are associated with a matrix, the matrix based on a quantity of available uplink band positions in available band combinations.

Aspect 5: The method of any of aspects 1 through 4, further comprising: receiving a table that identifies a set of integer values for each band combination in available band combinations, wherein the band combination identifier is associated with the table.

Aspect 6: The method of any of aspects 1 through 5, wherein the band combination identifier is associated with a number of concurrent uplink communications supported by the UE.

Aspect 7: The method of any of aspects 1 through 6, wherein the band combination identifier is associated with a number of bands in the plurality of band combinations supported by the UE and a number of uplink bands in each band combination.

Aspect 8: The method of aspect 7, further comprising: generating, according to a first algorithm, a set of unique integer values for each band combination in the available band combinations, wherein the band combination identifier is based on the set of unique integer values.

Aspect 9: The method of any of aspects 7 through 8, further comprising: generating, according to a second algorithm, the band combination identifier based on the number of bands in the plurality of band combinations supported by the UE and the number of uplink bands in each band combination.

Aspect 10: The method of any of aspects 1 through 9, wherein the UE capability message comprises a first information element that identifies a number of band combinations and second information element that identifies a number of uplink bands in each band combination.

Aspect 11: The method of any of aspects 1 through 10, wherein the UE capability message comprises an indication of a number of band combinations included in the plurality of band combinations supported by the UE.

Aspect 12: A method for wireless communications at a network entity, comprising: receiving a UE capability message that comprises a band combination identifier that identifies a plurality of band combinations supported by the UE for wireless communications, wherein each identifier in the band combination identifier corresponds to a sequential position of uplink bands within each band combination of the plurality of band combinations and each band combination comprises a sequential listing of both uplink bands and downlink bands; and performing the wireless communications with the UE using one or more band combinations of the plurality of band combinations supported by the UE in accordance with the UE capability message.

Aspect 13: The method of aspect 12, wherein the band combination identifier comprises a set of integer values, and each band combination in the plurality of band combinations is associated with a unique integer in the set of integer values.

Aspect 14: The method of aspect 13, wherein each unique integer corresponds to a sequential position of uplink bands in each band combination.

Aspect 15: The method of any of aspects 13 through 14, wherein the set of integer values are associated with a matrix, the matrix based on a quantity of available uplink band positions in available band combinations.

Aspect 16: The method of any of aspects 12 through 15, further comprising: transmitting a table that identifies a set of integer values for each band combination in available band combinations, wherein the band combination identifier is associated with the table.

Aspect 17: The method of any of aspects 12 through 16, wherein the band combination identifier is associated with a number of concurrent uplink communications supported by the UE.

Aspect 18: The method of any of aspects 12 through 17, wherein the band combination identifier is based on a number of bands in the plurality of band combinations supported by the UE and a number of uplink bands in each band combination.

Aspect 19: The method of aspect 18, further comprising: generating, according to a first algorithm, a set of unique integer values for each band combination in the available band combinations, wherein the band combination identifier is based on the set of unique integer values.

Aspect 20: The method of any of aspects 18 through 19, wherein the band combination identifier is based on the number of bands in the plurality of band combinations supported by the UE and the number of uplink bands in each band combination.

Aspect 21: The method of any of aspects 12 through 20, wherein the UE capability message comprises a first information element that identifies a number of band combinations and second information element that identifies a number of uplink bands in each band combination.

Aspect 22: The method of any of aspects 12 through 21, wherein the UE capability message comprises an indication of a number of band combinations included in the plurality of band combinations supported by the UE.

Aspect 23: A UE for wireless communications, comprising a processing system that includes processor circuitry and memory circuitry that stores code, the processing system configured to cause the UE to perform a method of any of aspects 1 through 11.

Aspect 24: A UE for wireless communications, comprising at least one means for performing a method of any of aspects 1 through 11.

Aspect 25: A non-transitory computer-readable medium storing code for wireless communications, the code comprising instructions executable by one or more processors to perform a method of any of aspects 1 through 11.

Aspect 26: A network entity for wireless communications, comprising a processing system that includes processor circuitry and memory circuitry that stores code, the processing system configured to cause the network entity to perform a method of any of aspects 12 through 22.

Aspect 27: A network entity for wireless communications, comprising at least one means for performing a method of any of aspects 12 through 22.

Aspect 28: A non-transitory computer-readable medium storing code for wireless communications, the code comprising instructions executable by one or more processors to perform a method of any of aspects 12 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a UE capability message that comprises a band combination identifier that identifies a plurality of band combinations supported by the UE for wireless communications, wherein each identifier in the band combination identifier corresponds to a sequential position of uplink bands within each band combination of the plurality of band combinations and each band combination comprises a sequential listing of both uplink bands and downlink bands; and
perform the wireless communications using one or more band combinations of the plurality of band combinations supported by the UE in accordance with the UE capability message.

2. The UE of claim 1, wherein the band combination identifier comprises a set of integer values, and wherein each band combination in the plurality of band combinations is associated with a unique integer in the set of integer values.

3. The UE of claim 2, wherein each unique integer corresponds to a sequential position of uplink bands in each band combination.

4. The UE of claim 2, wherein the set of integer values are associated with a matrix, the matrix based on a quantity of available uplink band positions in available band combinations.

5. The UE of claim 1, wherein the one or more processors are individually or collectively further operable to execute the code to cause the UE to:
receive a table that identifies a set of integer values for each band combination in available band combinations, wherein the band combination identifier is associated with the table.

6. The UE of claim 1, wherein the band combination identifier is associated with a number of concurrent uplink communications supported by the UE.

7. The UE of claim 1, wherein the band combination identifier is associated with a number of bands in the plurality of band combinations supported by the UE and a number of uplink bands in each band combination.

8. The UE of claim 7, wherein the one or more processors are individually or collectively further operable to execute the code to cause the UE to:
generate, according to a first algorithm, a set of unique integer values for each band combination in the available band combinations, wherein the band combination identifier is based on the set of unique integer values.

9. The UE of claim 7, wherein the one or more processors are individually or collectively further operable to execute the code to cause the UE to:
generate, according to a second algorithm, the band combination identifier based on the number of bands in the plurality of band combinations supported by the UE and the number of uplink bands in each band combination.

10. The UE of claim 1, wherein the UE capability message comprises a first information element that identifies a number of band combinations and second information element that identifies a number of uplink bands in each band combination.

11. The UE of claim 1, wherein the UE capability message comprises an indication of a number of band combinations included in the plurality of band combinations supported by the UE.

12. A network entity, comprising:
one or more memories storing processor-executable code; and
one or more processors coupled with the one or more memories and individually or collectively operable to execute the code to cause the network entity to:
receive a user equipment (UE) capability message that comprises a band combination identifier that identifies a plurality of band combinations supported by the UE for wireless communications, wherein each identifier in the band combination identifier corresponds to a sequential position of uplink bands within each band combination of the plurality of band combinations and each band combination comprises a sequential listing of both uplink bands and downlink bands; and
perform the wireless communications with the UE using one or more band combinations of the plurality of band combinations supported by the UE in accordance with the UE capability message.

13. The network entity of claim 12, wherein the band combination identifier comprises a set of integer values, and wherein each band combination in the plurality of band combinations is associated with a unique integer in the set of integer values.

14. The network entity of claim 13, wherein each unique integer corresponds to a sequential position of uplink bands in each band combination.

15. The network entity of claim 13, wherein the set of integer values are associated with a matrix, the matrix based on a quantity of available uplink band positions in available band combinations.

16. The network entity of claim 12, wherein the one or more processors are individually or collectively further operable to execute the code to cause the network entity to:
transmit a table that identifies a set of integer values for each band combination in available band combinations, wherein the band combination identifier is associated with the table.

17. The network entity of claim 12, wherein the band combination identifier is associated with a number of concurrent uplink communications supported by the UE.

18. The network entity of claim 12, wherein the band combination identifier is based on a number of bands in the plurality of band combinations supported by the UE and a number of uplink bands in each band combination.

19. The network entity of claim 18, wherein the one or more processors are individually or collectively further operable to execute the code to cause the network entity to:
generate, according to a first algorithm, a set of unique integer values for each band combination in the available band combinations, wherein the band combination identifier is based on the set of unique integer values.

20. A method for wireless communications at a user equipment (UE), comprising:
transmitting a UE capability message that comprises a band combination identifier that identifies a plurality of band combinations supported by the UE for wireless communications, wherein each identifier in the band combination identifier corresponds to a sequential position of uplink bands within each band combination of the plurality of band combinations and each band combination comprises a sequential listing of both uplink bands and downlink bands; and
performing the wireless communications using one or more band combinations of the plurality of band combinations supported by the UE in accordance with the UE capability message.
